(19) United States
(12) Patent Application Publication
(10) Pub. No.: US 2007/0294436 A1
(43) Pub. Date: Dec. 20, 2007

(54) APPARATUS AND METHOD FOR SCANNING SLAVE ADDRESSES OF SMBUS SLAVE DEVICES

(76) Inventors: Ming-Feng CHEN, Taipei City (TW); Chun-Hsu CHEN, Taipei City (TW)

Correspondence Address: RABIN & Berdo, PC, 1101 14TH STREET, NW, SUITE 500, WASHINGTON, DC, 20005, US

(21) Appl. No.: 11/684,816

(22) Filed: Mar. 12, 2007

(30) Foreign Application Priority Data
Jun. 15, 2006 (TW) 095121328

(51) Int. Cl. G06F 3/00; G06F 13/14

(52) U.S. Cl. 710/3; 710/110

(57) ABSTRACT

An apparatus and a method are provided to scan the slave addresses of plural slave devices connected to a system management bus (SMBus). By means of signal simulation corresponsive to an address section of SMBus Packet Protocols, a scan process unit of the apparatus generates plural scan packets and sends to the SMBus for plural address acknowledgements from the corresponding slave devices. Therefore, the distribution of the slave addresses may be easily discovered by the scan method without causing any malfunction of the slave devices.

### BACKGROUND OF THE INVENTION

1. Field of Invention

The present invention relates to a scan apparatus for slave address, and more particularly to an apparatus and a method for scanning the slave addresses of SMBus devices.

2. Related Art

To communicate with various slave devices connected to a system management bus, the slave address of the slave devices need to be assigned in advance for identification of the signal/data transmission. When a computer system is booted, the SMBus controller will scan the slave devices for confirming the slave addresses.

Generally, most of the SMBus controllers are integrated into the South Bridge. Namely, the SMBus scan procedures and the control mechanism of the slave addresses are not allowed to be modified by the system designers. Besides, the assignment of the slave address is enabled by the voltage levels of specific pins on the slave devices. These specific pins of the slave devices, controlling the slave address registers, are further controlled via the circuit layout. If any changes of the slave addresses need to be made, the circuit layout has to be modified accordingly, which causes extra time and cost. Therefore, the conflicts of the slave addresses between various slave devices become extremely troublesome.

A common system error found in the SMBus is caused by the scan process of the SMBus controller. The slave devices configured on the SMBus will be malfunctioned or crashed due to the bus protocol conflicts between the transmitted SMBus packets of the scan process and the dedicated SMBus protocol for each of the slave devices. And in general, a failed slave device results in a wrong scan result to the SMBus controller. Eventually, the SMBus controller fails to normally drive and control all the slave devices due to the wrong scan result.

Please refer to FIGS. 1A and 1B, which illustrates respectively a basic structure of the SMBus packet and a connection architecture between a master device and the slave devices, according to the SMBus in the prior art. The SMBus provides 9 different bus packet protocols for all types of the slave devices, including Quick Command, Send Byte, Receive Byte, Write Byte/Word, Read Byte/Word, Process Call, Block Write/Read, Block Write-Block Read Process Call and SMBus Host Notify Protocol. Each of the transmitted SMBus packet has an address section 11 and a data section 12; wherein the address sections of all the nine packets has the same structure, while the data sections vary from one packet to another.

In FIG. 1B, the SMBus controller 20 follows the clock pulse transmitted in the Clock bus (CLK) of the SMBus 21 to send a complete SMBus packet in the data bus (DAT) bit by bit to the slave devices 221˜226 connected to the SMBus 21.

In FIG. 1A, the address section 11 of the SMBus packet 10 includes a START bit (S), a SLAVE ADDRESS byte (SA), a READ/WRITE bit (R/W) and an ADDRESS ACKNOWLEDGEMENT bit (As). On the other hand, the data section 12 has a DATA byte (D), a DATA ACKNOWLEDGEMENT bit (Ad), a STOP CONDITION bit (P) . . . , and so on. Some certain packets further include a PACKET ERROR CODE (PEC), or multiple DATA bytes (D) and DATA ACKNOWLEDGEMENT bit (Ad). Only the ADDRESS ACKNOWLEDGEMENT bit (As) and the DATA ACKNOWLEDGEMENT bit (Ad) are responded respectively by the slave devices according to the SLAVE ADDRESS byte SA and the DATA byte.

If the SLAVE ADDRESS byte SA in the address section 11 of the SMBus packet 10 transmitted from the SMBus controller 20 to the SMBus 11 is assigned to the slave device 224, the slave device 224 will respond with an “address acknowledgement” during an “address acknowledgement clock period” of the clock bus CLK.

However, if the later half of the SMBus packet 10, which is the data section 12, does not match the dedicated SMBus protocols of the slave device 224, the slave device 224 will be failed or crashed. Even though next time the SMBus controller 20 may transmit another SMBus packet 10 with the correct protocols, the slave device 224 will still be hanging on the malfunction state and failed to respond, or, operated abnormally. Consequently, while the SMBus controller 20 is performing the system commands toward the slave device 224 according to the scan result, different failures will possibly happen with unknown reasons.

At the moment, even a reboot procedure may solve the crash state of the slave device 224, the inevitable scan process during the reboot procedure will cause the slave device 224 a malfunction again. In a scan process performed under a DOS system, a SMBus command “kill” may erase the former packet with the wrong protocols. However, it cannot solve the malfunction of the slave devices. As a result, two scan processes performed by the SMBus controller with the same packet protocols will obtain two different results and bring an arduous problem to the control of the slave devices.

Another possible problem found in the scan process is about the unknown slave devices. Some chips or controllers that link to the SMBus have more than one internal slave devices embedded therein. Those slave devices ignored during the early stages of system design would possibly become the sources that cause unknown system failures. The unknown slave devices mentioned above are lack of information, and usually cannot be shown through the scan result.

### SUMMARY OF THE INVENTION

To solve the technical problems mentioned above, the present invention provides an apparatus and a method for scanning the slave address of SMBus slave devices. The apparatus and method utilizes signal simulation technologies to generate a scan packet according to an address section of SMBus Packet Protocols, and then transmit to the SMBus. Therefore the distribution status of the slave addresses may be confirmed according to at least one address acknowledgement from the slave devices. Accordingly, all the slave devices connected to the SMBus will be scanned precisely, and the failure problem of the slave devices caused by the scan procedures will be prevented as well.

The apparatus for scanning the slave addresses according to a preferred embodiment of the present invention includes a connection port, an adaptor box and a scan processing unit. The adaptor box has plural connection terminals, compatible and electrically connecting with the SMBus and the connection port. The scan processing unit is in circuit connection with the connection port for controlling communications thereof. The scan processing unit has a clock pin and a data pin, for generating and transmitting a scan packet to the SMBus, and for receiving a plurality of address acknowledgements from the slave devices.

The method for scanning the slave addresses according to a preferred embodiment of the present invention includes the following steps: (1) generate a scan packet according to a scan address and transmit to the SMBus; (2) confirm whether an address acknowledgement is received during an address acknowledgement clock period; and (3) record in a slave address table.

Another scan method according to another preferred embodiment of the present invention is to scan the slave addresses of plural slave devices connected to the SMBus on the mother board. Equipped with a clock pin and a data pin, the Southbridge is in circuit connection with the SMBus to generate/transmit a scan packet in accordance with the scan address to the SMBus. Eventually, confirm whether an address acknowledgement is received during an address acknowledgement clock period.

According to the preferred embodiments of the present invention, the scan packet described above in compatible with the address section of the SMBus Packet Protocols.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1A is an explanatory diagram of SMBus Packet Protocols in the prior art.

FIG. 1B is an explanatory block diagram of SMBus connection architecture in the prior art.

FIG. 2A is an explanatory block diagram of a scan apparatus according to a preferred embodiment of the present invention.

FIG. 2B is an explanatory diagram of another scan apparatus according to another preferred embodiment of the present invention.

FIG. 3A is an explanatory diagram of signal simulation mechanism for SMBus Packet Protocols according to a preferred embodiment of the present invention.

FIG. 3B is an explanatory flow chart of a scan method according to another preferred embodiment of the present invention.

FIG. 4 is an explanatory diagram of another scan apparatus according to another preferred embodiment of the present invention.

FIG. 5 is an explanatory diagram of another scan apparatus according to another preferred embodiment of the present invention.

### DETAILED DESCRIPTION OF THE INVENTION

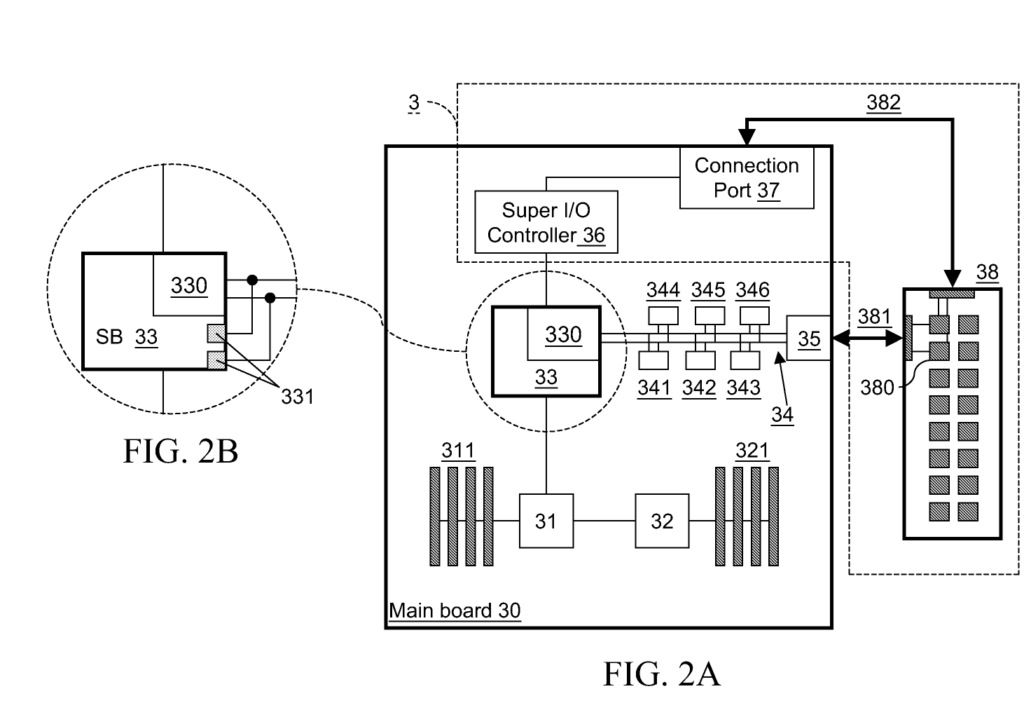

Please refer to FIG. 2A, which illustrates a preferred embodiment applying the present invention in a dual-processor system. A mother board 30 includes two processors 31, 32, each having plural dedicated system memories 311, 321. The processor 31 is in circuit connection with a Southbridge 33. Except connecting to a super input/output controller 36 and a connection port 37, the Southbridge 33 has a SMBus controller 330 connecting to plural slave devices 341, 342, 343, 344, 345, 346 through the SMBus 34.

The scan apparatus 3 for the slave addresses disclosed in the present embodiment includes the super I/O controller 36, the connection port 37 and an adaptor box 38. The mother board 30 is configured with a pin header 35, which electrically connects to the SMBus 34, and through the first signal cable 381 to two of the connection terminals 380 in the adaptor box 38. All of the connection terminals 380 of the adaptor box 38 are mainly compatible with the connection port 37, while the SMBus 34 may only connect with two of the connection terminals 380 through the first signal cable 381. The connection port 37 and the adaptor box 38 are connected with a second signal cable 382. The super I/O controller 36 is operating as a scan processing unit. Except electrically connecting and controlling the connection port 37, the super I/O controller 36 has a clock pin and a data pin (both not shown) for generating and transmitting the scan packets to the SMBus 34, and for receiving the address acknowledgements transmitted from the slave devices 341, 342, 343, 344, 345, 346. Therefore, the communication paths for the super I/O controller 36 and the slave devices 341, 342, 343, 344, 345, 346 on the SMBus 34 may be thus established. In general, the super I/O controller 36 is integrated with a floppy disk controller, a keyboard/mouse controller, a printer controller and a serial port controller, and usually capable of controlling the communications of a parallel port and the serial port.

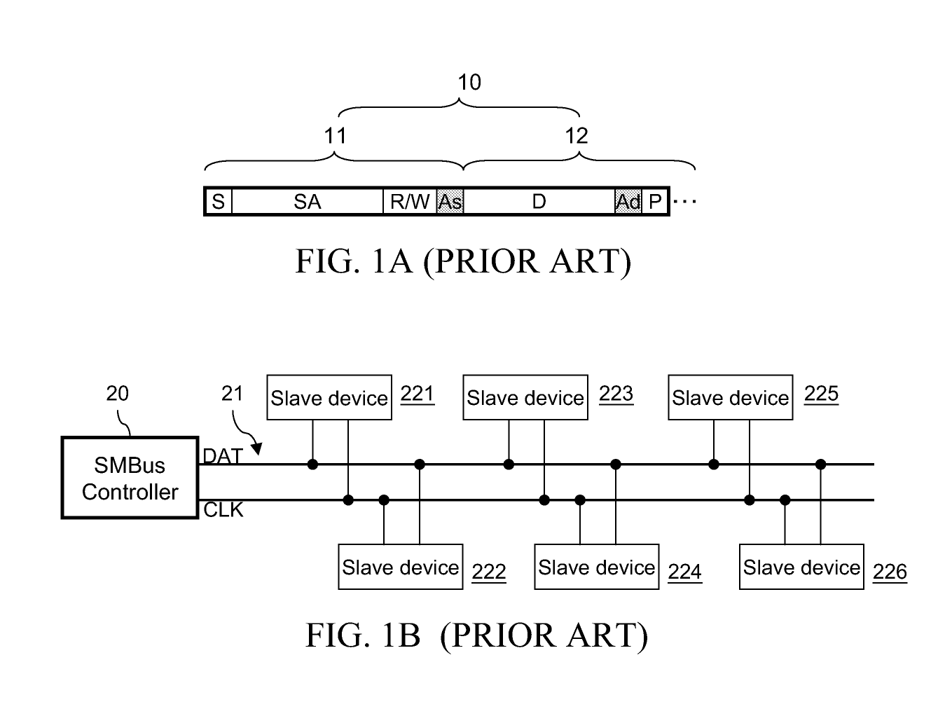

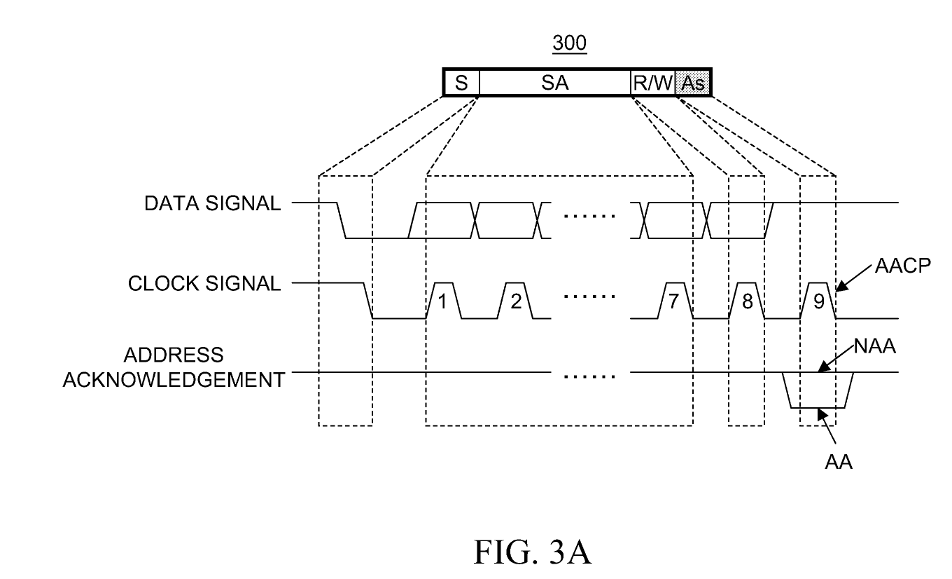

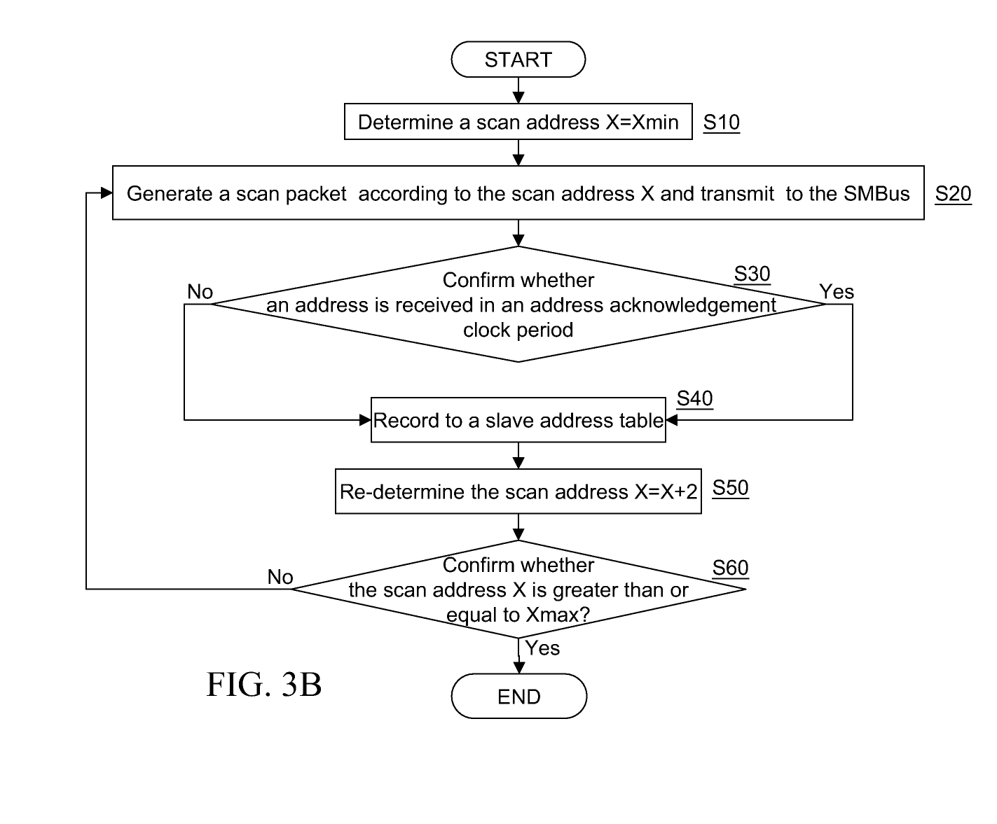

Please refer to FIGS. 3A and 3B, accompanying with FIGS. 1A and 1B. The super I/O controller 36 does not actually transmit a standard SMBus packet as the scan packet 300. Instead, the super I/O controller simulates the wave shapes of the signal pulses of the SMBus packet. In FIG. 3A, the wave shape of the clock signal transmitted by the super I/O controller 36, is simulated from the clock bus CLK of the SMBus 21 in FIG. 1B. Since the format error of the data section 12 is one of the reasons that cause the slave device failure, as mentioned in the background, the scan packet 300 only simulates the address section 11 of the SMBus packet 10.

In FIG. 3A, after the START bit S, the clock pin of the super I/O controller 36 will continuously transmit the clock pluses 1, 2 . . . 7, 8, 9. During the durations of the clock pulses 1˜7, the data pin of the super I/O controller 36 will then transmit data signals simulated as the SMBus packet format and corresponsive to the SLAVE ADDRESS byte SA of the scan packet 300. The eighth clock pulse 8 is corresponsive to the READ/WRITE bit R/W of the scan packet 300. The ninth clock pulse 9, counted after the scan processing unit transmits the START bit, and corresponsive to the ADDRESS ACKNOWLEDGEMENT bit As of the scan packet 300, is compatible with the address acknowledgement clock period “AACP” of the SMBus packet protocol. If any of the slave devices responses in the address acknowledgement clock period AACP with an address acknowledgement AA, the slave address responsive to the SLAVE ADDRESS byte SA has been taken by the acknowledging slave device. On the other hand, a NAA (non-address-acknowledgement) is the opposite; the corresponsive slave address is available. To avoid conflicts, the address acknowledge AA is mostly sent by the data bus of the SMBus, and received by the data pin of the scan process unit. Namely, the super I/O controller 36 transmits the clock pulses and the data signals through the clock pin and the data pin respectively, with the clock pulses and the data signals generated by way of signal simulation to be compatible with SMBus Packet Protocols. As to the practical way of signal simulation for clock pulses or data signals in a SMBus, the scan processing unit may simply generates electrical pulses that have the same logic levels (0 or 1) as the simulated clock pulses or data signals.

Please refer to FIG. 3B, which illustrates an embodiment about a scan method for the slave address according to the present invention.

The initial scan address X may be the greatest slave address Xmax or the smallest slave address Xmin to start to scan all of the slave address. According to SMBus Packet Protocols, the SLAVE ADDRESS byte SA includes 7 bits. As to the binary registers of the common slave devices, there are up to 128 (27) slave address available. The scan method should use all the 128 slave addresses as the scan addresses to execute the scan operation to cover all the possibilities.

In step S10, the scan address X is determined to be the smallest slave address Xmin. That is to scan from the smallest slave address and to repeat the procedure with a progressively increased slave address time by time. The super I/O controller 36 may perform a binary transformation for the slave address Xmin, adding with the START bit S and the READ(WRITE) bit Rd(Wr), to generate a scan packet 300 according to the slave address X, and to transmit through the communication path in FIG. 2A to the SMBus 34 (step S20). The wave shape of the data signal in the scan packet 300 will be corresponsive to and compatible with the address section 11 of the SMBus packet. As mentioned above, the scan packet 300 is generated by signal simulation, so step S20 may further include the following steps: (a) generating plural clock pulses and plural data signals according to the scan address by way of signal simulation of SMBus Packet Protocols; (b) transmitting the clock pulses and the data signals respectively to the clock bus and the data bus of the SMBus.

Next in step S30, during the duration of the clock pulse 9 shown in FIG. 3A, namely the address acknowledgement clock period AACP, the scan method needs to confirm whether an address acknowledgement AA is received. In a situation of non-address-acknowledgement NAA, the data pin of the super I/O controller 36 will not receive any data signal during the address acknowledgement clock period AACP. No matter the address acknowledgement AA is received or not, the scan results may all be recorded to a slave address table (step S40). The slave address able may be a simple matrix of slave address to slave device, or including further descriptions of the slave devices and the slave address. The format of the slave address table should be set up by user demand with no limitations. Afterwards, re-determine the scan address X=X+2 (step 50); and then confirm whether the scan address X is greater than or equal to Xmax? (step 60) Then return to step S20 and continue to scan, until all the possible 128 slave address have been scanned. And since the scan packet has no data section like the SMBus packet, the scan packet with only address section will not cause any failure to the slave devices.

In short, the scan method of the slave address disclosed in the preferred embodiment mainly includes the generating and transmitting operations of the scan address, the receiving operation of the address acknowledgement, and the recording process of the slave address table.

In practice, while using the scan apparatus of the present invention to perform the scan processes of the slave address, a computer program including software or firmware may need to be compiled in accordance with the aforesaid scan steps. Only the scan processing unit that actually executes the scan procedures is not limited to aforesaid super I/O controller 36. A controller that has two signal pins for input and output the SMBus-compatible signals will be possible to realize the present invention, such as an input/output controller equipped with GPIO (general purpose input/output) pins and cooperating with a proper connection port 37 and an adaptor box 38. For those I/O controllers equipped with GPI (general purpose input) pin and GPO (general purpose output) pins, only using a pair of GPO pins for transmit the scan packet, along with a pair of GPI pins for detecting or receiving the address acknowledgement AA, will be able to achieve the same result as the former embodiment. The differences will be in this application there are two clock pins (one GPI pin and one GPO pin), and two data pins (one GPI pin and one GPO pin).

In the embodiments disclosed above, the super I/O controller 36 that operates as the scan processing unit is capable of controlling the parallel port and the serial port, so practically the connection port 37 may be a parallel port or a serial port. Except the super I/O controller 36, the Southbridge (SB) 33 may be utilized as the scan processing unit, as shown in FIG. 2B. The Southbridge 33 has two GPIO pins 331 used as the clock pin and the data pin. The two GPIO pins are electrically connected to the SMBus 34. Once the Southbridge 33 is provided with an appropriate computer program to execute the aforesaid scan method, a complete scan result of the slave address will be accordingly obtained.

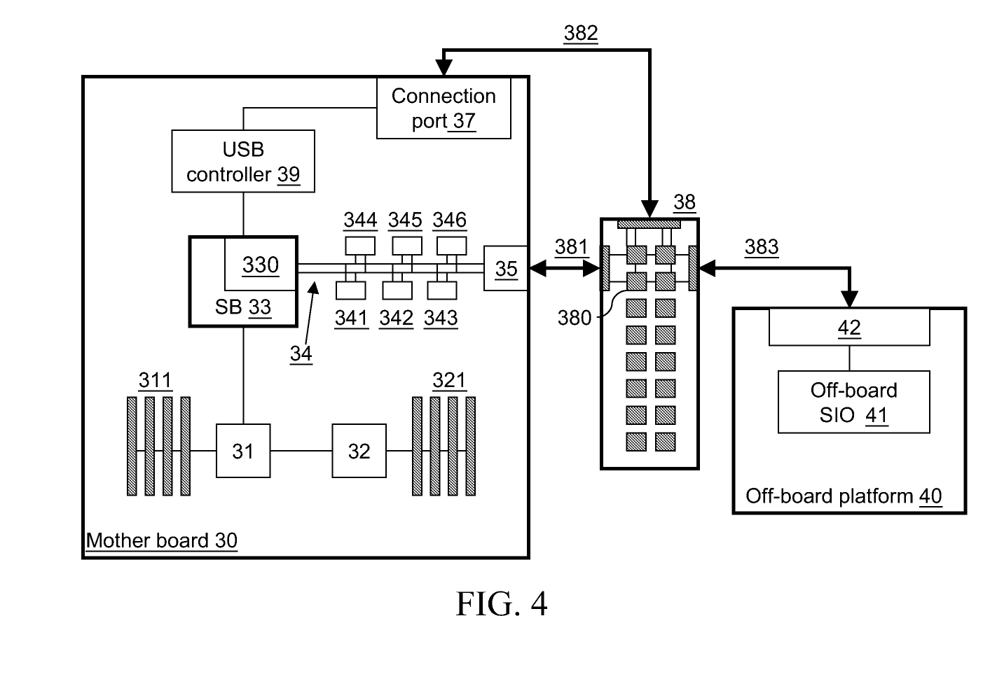

Please refer to FIG. 4. An off-board solution or USB (universal serial bus) platform is able to realize the present invention. In the USB application, the connection port 37 has to be compatible with USB Protocols to cooperate with a USB controller 39 that operates as a scan processing unit. In the off-board application, an off-board platform 40 has an off-board SIO (super I/O controller) 41 operating as a scan processing unit. The off-board SIO 41 generates and transmits the scan packet through an off-board connection port 42 (maybe a parallel port or a serial port), a third signal cable 383, an adaptor box 38, the first signal cable 381 and the pin header 35 to the SMBus 34. Similarly, the off-board SIO 41 is to receive the address acknowledgement AA.

Both of said USB controller 39 and off-board SIO 41 need to be provide with dedicated computer program to execute the scan method of the slave address, as described above. Hence no matter the locations of the connection port and the scan processing unit (on-board super I/O controller, USB controller or off-board SIO) are on the mother board or not, the present invention may still be realized.

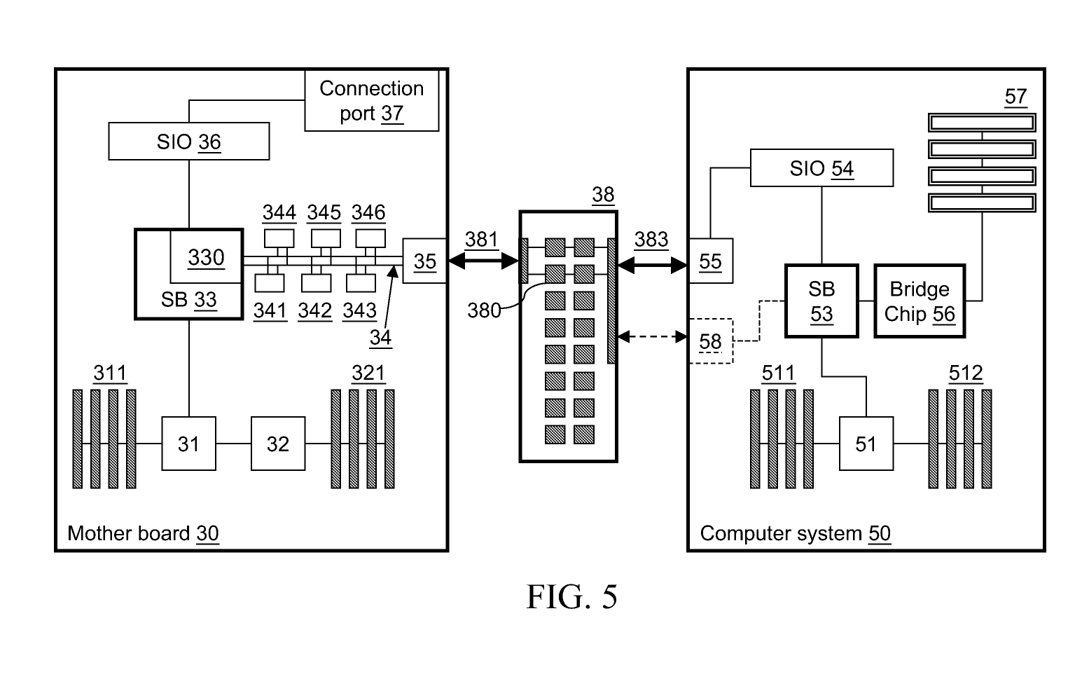

Please refer to FIG. 5. Another off-board solution is for another computer system 50 to scan the slave addresses on the mother board 30. The computer system 50 is a single processor system with a processor 51. The processor 51 is equipped with system memories 511 and 512. Except the connection to the Southbridge 53, the processor 51 is in circuit connection with extension buses 57 through a bridge chip 56. The super I/O controller 54, connecting with the Southbridge 53 and operating as a scan processing unit, generates and transmits the scan packet through the connection port 55, the third signal cable 383, the adaptor box 38, the first signal cable 381 and the pin header 35 to the SMBus 34. The super I/O controller 54 is used to receive the address acknowledgement AA as well. As disclosed in the former embodiment, the computer system 50 may use the USB controller (not shown) or the Southbridge 53 as the scan processing unit.

Taking the Southbridge 53 as an example, the Southbridge 53 may connect directly or indirectly to the pin header 35 through the pin header 58 to establish the communication path required in the scan procedures. That means, if the Southbridge is used as a scan processing unit, no matter for an off-board or on-board solution, the Southbridge will need at least one clock pin and at least one data pin to electrically connect the SMBus. According to the scan procedures in FIG. 3B, the Southbridge may simulates SMBus Packet Protocols to generate clock pulses and data signals corresponsive to the scan addresses; and then transmit through its clock pin and data pin to the clock bus and the data bus of the SMBus. Afterwards the address acknowledgement will be confirmed to be received in the address acknowledgement clock period; and thus to set up the slave address table.

The circuit connection used in the present invention includes varies connection means with circuits, including printed circuit board, flexible printed circuit board, necessary signal cables or connectors, without limitations to on-board or off-board solutions.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for scanning a plurality of slave addresses of a plurality of slave devices, the slave devices being connected to a SMBus (system management bus) located on a mother board, the apparatus comprising:
a connection port;
an adaptor box, comprising a plurality of connection terminals compatible and electrically connecting with the SMBus and the connection port; and
a scan processing unit, in circuit connection with the connection port for controlling communications thereof, generating a plurality of scan packets for transmitting through the connection port and the adaptor box to the SMBus, and receiving a plurality of address acknowledgements from the slave devices;
wherein, the scan packet is compatible with an address section of SMBus Packet Protocols.

2. The apparatus of claim 1, wherein the scan processing unit comprises at least one clock pin and at least one data pin.

3. The apparatus of claim 2, wherein the clock pin is for transmitting a plurality of clock pulses to a clock bus of the SMBus, the clock pulses being compatible with SMBus Packet Protocols by way of signal simulation.

4. The apparatus of claim 2, wherein the data pin is for transmitting a plurality of data signals to a data bus of the SMBus, the data signals being compatible with SMBus Packet Protocols by way of signal simulation.

5. The apparatus of claim 1, wherein the scan packet comprises a START bit, a SLAVE ADDRESS byte, a READ/WRITE bit and an ADDRESS ACKNOWLEDGEMENT bit.

6. The apparatus of claim 1, wherein the scan processing unit receives the address acknowledgement during an address acknowledgement clock period of SMBus Packet Protocols.

7. The apparatus of claim 6, wherein the address acknowledgement clock period is corresponsive to the ninth clock pulse transmitted through the clock pin, the ninth clock pulse being counted after the scan processing unit transmitting the START bit.

8. The apparatus of claim 1, wherein the mother board comprises a pin header electrically connecting to the SMBus and the adaptor box.

9. The apparatus of claim 1, wherein the scan processing unit is a super I/O controller or an USB (universal serial bus) controller.

10. The apparatus of claim 1, wherein the connection port is a parallel port or a serial port, or compatible with USB Protocols.

11. The apparatus of claim 1, wherein the connection port and the scan processing unit are located on or off the mother board.

12. A method for scanning a plurality of slave addresses of a plurality of slave devices, the slave devices being connected to a SMBus (system management bus) located on a mother board, the method comprising the steps of:
generating at least one scan packet according to at least one scan address and transmitting to the SMBus;
confirming whether an address acknowledgement is received during an address acknowledgement clock period; and
recording in a slave address table;
wherein, the scan packet is compatible with an address section of SMBus Packet Protocols.

13. The method of claim 12, wherein the step of generating and transmitting the scan packet comprises the following step:
generating a plurality of clock pulses and a plurality of data signals according to the scan address through signal simulation of SMBus Packet Protocols.

14. The method of claim 13, wherein the step of generating and transmitting the scan packet further comprises the following step:
transmitting the clock pulses and the data signals respectively to a clock bus and a data bus of the SMBus.

15. The method of claim 14, wherein the scan packet comprises a START bit, a SLAVE ADDRESS byte, a READ/WRITE bit and an ADDRESS ACKNOWLEDGEMENT bit.

16. The method of claim 15, wherein the address acknowledgement clock period is corresponsive to the ninth clock pulse transmitted to the clock bus, the ninth clock pulse being counted after the scan processing unit transmitting the START bit.

17. A method for scanning a plurality of slave address of a plurality of slave devices connected to a SMBus on a mother board, a Southbridge having at least one clock pin and at least one data pin in circuit connection with the SMBus, the Southbridge generating at least one scan packet according at least one scan address and transmitting to the SMBus, then confirming whether an address acknowledgement is received during an address acknowledgement clock period, the scan packet being compatible with an address section of SMBus Packet Protocols.

18. The method of claim 17, wherein the scan packet comprises a START bit, a SLAVE ADDRESS byte, a READ/WRITE bit and an ADDRESS ACKNOWLEDGEMENT bit.

19. The method of claim 18, wherein the address acknowledgement clock period is corresponsive to the ninth clock pulse transmitted through the clock pin, the ninth clock pulse being counted after the scan processing unit transmitting the START bit.

20. The method of claim 17, wherein the Southbridge generates a plurality of clock pulses and a plurality of data signals according to the scan address by signal simulation of SMBus Packet Protocols, and then transmitting through the clock pin and the data pin respectively to a clock bus and a data bus of the SMBus.
